(19) United States
(12) Patent Application Publication
(10) Pub. No.: US 2016/0155410 A1
(43) Pub. Date: Jun. 2, 2016

(54) DISPLAY METHOD AND APPARATUS WITH MULTI-SCREEN

(71) Applicant: SAMSUNG ELECTRONICS CO., LTD., Gyeonggi-do (KR)

(72) Inventor: Hyeong-Min NAM, Gyeonggi-do (KR)

(21) Appl. No.: 14/899,297

(22) PCT Filed: Apr. 1, 2014
(86) PCT No.: PCT/KR2014/002789

§ 371 Date: Dec. 17, 2015

(30) Foreign Application Priority Data
Jun. 25, 2013 (KR) 10-2013-0073332

(51) Int. Cl. G09G 5/00; G09G 5/373; G06T 3/40; G09G 5/38; G06F 3/14; G06F 3/0484

(52) U.S. Cl. CPC G09G 5/005; G06F 3/1415; G06F 3/04842; G06T 3/4092; G09G 5/38; G09G 5/373; G06F 3/04847; G09G 2300/026

(57) ABSTRACT

Provided is a method for displaying single content using a multi-screen comprised of heterogeneous terminals in a server terminal. The method includes, upon detecting access of client terminals which are to constitute the multi-screen, providing a user input request screen for a layout of the server terminal and the client terminals for the multi-screen; after sending an instruction to provide the user input request screen to each of the client terminals, detecting the layout and a bezel area between the server terminal and the client terminals on the multi-screen using a user input detected by the server terminal, and user inputs received from the client terminals; and controlling display of the multi-screen using the detected layout and bezel area.

### TECHNICAL FIELD

The present invention provides a method and apparatus for displaying single content using a multi-screen comprised of heterogeneous terminals.

### BACKGROUND ART

In recent years, due to an increase in the user demand for multi-screen display and the prevalence of user terminals, there is a need for a method of displaying single content using a plurality of screens. For example, a user may connect an additional monitor to a laptop Personal Computer (PC) to enjoy one laptop-PC screen with dual monitors, or may arrange multiple monitors on a billboard, for product advertisement, providing them as a single screen. In this case, in order to naturally display single content on a multi-screen, there is a need for a display method and apparatus that takes into account the screen resolution, actual design and the like of display terminals constituting the multi-screen.

The above information is presented as background information only to assist with an understanding of the present disclosure. No determination has been made, and no assertion is made, as to whether any of the above might be applicable as prior art with regard to the present invention.

### DISCLOSURE OF INVENTION

### Technical Problem

An aspect of the present invention is to address at least the above-mentioned problems and/or disadvantages and to provide at least the advantages described below. Accordingly, an aspect of the present invention is to provide a method and apparatus for displaying single content using a multi-screen comprised of heterogeneous terminals.

Another aspect of the present invention is to provide a method and apparatus for displaying single content on a multi-screen taking into account the Pixels Per Inch (PPI) and bezel of each display of heterogeneous terminals constituting the multi-screen on which the single content is to be displayed.

### Solution to Problem

In accordance with an aspect of the present invention, there is provided a method for displaying single content using a multi-screen comprised of heterogeneous terminals in a server terminal. The method includes, upon detecting access of client terminals which are to constitute the multi-screen, providing a user input request screen for a layout of the server terminal and the client terminals for the multi-screen; after sending an instruction to provide the user input request screen to each of the client terminals, detecting the layout and a bezel area between the server terminal and the client terminals on the multi-screen using a user input detected by the server terminal, and user inputs received from the client terminals; and controlling display of the multi-screen using the detected layout and bezel area.

In accordance with another aspect of the present invention, there is provided a method for displaying single content using a multi-screen comprised of heterogeneous terminals in a client terminal. The method includes receiving, from a server terminal, an instruction to provide a user input request screen for a layout of client terminals for the multi-screen; upon detecting a user input, transmitting coordinates and time information for the user input to the server terminal; and performing display based on the layout and information about a bezel between the server terminal and other client terminals in the multi-screen, and information related to content to be displayed, wherein the layout and the information about the bezel is obtained from the server terminal.

In accordance with further another aspect of the present invention, there is provided a server terminal for displaying single content using a multi-screen comprised of heterogeneous terminals. The server terminal includes a transmitting/receiving unit for, upon detecting access of client terminals which are to constitute the multi-screen, sending an instruction to provide a user input request screen for a layout of the server terminal and the client terminals, to each of the client terminals, and receiving user inputs from the client terminals; and a controller for providing the user input request screen for a layout of the client terminals, for the multi-screen, detecting the layout and a bezel area between the server terminal and the client terminals on the multi-screen, based on the user inputs, and controlling display of the multi-screen using the detected layout and bezel area.

In accordance with yet another aspect of the present invention, there is provided a client terminal for displaying single content using a multi-screen comprised of heterogeneous terminals. The client terminal includes a transmitting/receiving unit for receiving, from a server terminal, an instruction to provide a user input request screen for a layout of client terminals for the multi-screen, and upon detecting a user input, transmitting coordinates and time information for the user input to the server terminal; and a controller for performing display based on the layout and information about a bezel between the server terminal and other client terminals in the multi-screen, and information related to content to be displayed, wherein the layout and the information about the bezel is obtained from the server terminal.

Other aspects, advantages, and salient features of the invention will become apparent to those skilled in the art from the following detailed description, which, taken in conjunction with the annexed drawings, discloses exemplary embodiments of the invention.

### Advantageous Effects of Invention

The present invention provides a display method in which the PPI and bezel are taken into consideration, for each display of heterogeneous terminals constituting a multi-screen, on which single content is to be displayed, thereby making it possible to configure a multi-screen with a simple manipulation such as user's touch input, contributing to remarkable improvement of User Experience (UX). The present invention may be applied to various types of terminals without being limited to the OS of a specific terminal, since it is provided in the form of application regardless of the OS of terminals.

### BRIEF DESCRIPTION OF DRAWINGS

The above and other aspects, features and advantages of certain exemplary embodiments of the present invention will be more apparent from the following description taken in conjunction with the accompanying drawings, in which:

FIG. 1a illustrates an example of a case in which in the existing display expansion method, when the same content is actually displayed on a multi-screen, its view size may vary due to the difference in Pixels Per Inch (PPI) between display terminals;

FIG. 1b illustrates an example of a case in which in the existing display expansion method, the content is discontinuously displayed due to the difference between display terminals used for a multi-display in terms of the thickness of physical bezels of the display terminals;

FIG. 2 illustrates an example of a case in which various heterogeneous displays are applied to content in the existing display expansion method;

FIG. 3 illustrates an example of applying a multi-display to single content according to an exemplary embodiment of the present invention;

FIG. 4 illustrates an example of a structure of a server terminal according to an exemplary embodiment of the present invention;

FIG. 5 illustrates an example of a structure of a client terminal according to an exemplary embodiment of the present invention;

FIG. 6 illustrates a method of displaying single content in an expanded display area which is laid out using a plurality of heterogeneous display terminals, according to an exemplary embodiment of the present invention;

FIG. 7a illustrates an example of a user input for application of a multi-display according to an exemplary embodiment of the present invention;

FIG. 7b illustrates an example of a method of obtaining a bezel size required during application of a multi-display and a layout of a display area based on the coordinates for a user's touch input according to an exemplary embodiment of the present invention;

FIG. 7c illustrates an example of a method of selecting a layout of heterogeneous terminals constituting an expanded display area by providing a user selection request screen for application of a multi-display according to another exemplary embodiment of the present invention;

FIG. 8 illustrates an example of a case in which a server terminal stores in advance in its DB the bezel information of target terminals to which it will apply a multi-display, according to an exemplary embodiment of the present invention;

FIG. 9 illustrates an example of a layout and a bezel thickness of an expanded display area comprised of target terminals to which a multi-display is to be applied, which are obtained by a server terminal, according to an exemplary embodiment of the present invention;

FIG. 10a illustrates the maximum size of an expanded display area comprised of target terminals to which a multi-display is to be applied, which are obtained by a server terminal, according to an exemplary embodiment of the present invention;

FIG. 10b illustrates the minimum size of an expanded display area comprised of target terminals to which a multi-display is to be applied, which are obtained by a server terminal, according to an exemplary embodiment of the present invention;

FIG. 11 illustrates an example in which content is placed, when the minimum size of an expanded display area is selected, to which a multi-display is applied, according to an exemplary embodiment of the present invention;

FIG. 12 illustrates exemplary display of content relocated in an expanded display area according to an exemplary embodiment of the present invention;

FIG. 13 is a flowchart illustrating an exemplary operation of a server terminal according to an exemplary embodiment of the present invention; and

FIG. 14 is a flowchart illustrating an exemplary operation of a client terminal according to an exemplary embodiment of the present invention.

Throughout the drawings, like reference numerals will be understood to refer to like parts, components, and structures.

### MODE FOR THE INVENTION

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skilled in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

A way to enjoy multi-screen display on a monitor of the existing Personal Computer (PC) will be assumed as a typical example of a method of displaying single content on a multi-screen. In this case, by arranging display terminals around the monitor in a horizontal or vertical direction, a multi-display may be applied, which expands the screen on which the content is displayed. As a variety of display terminals are used, even though the number of pixels of a screen is the same, its actual physical size may be different depending on the sizes and resolutions of the display terminals.

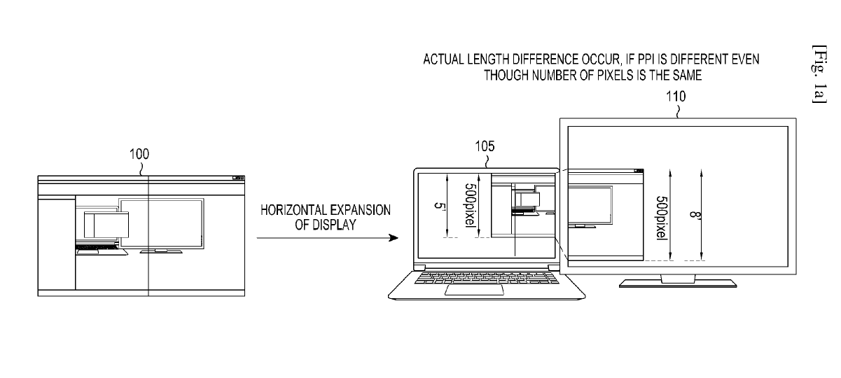

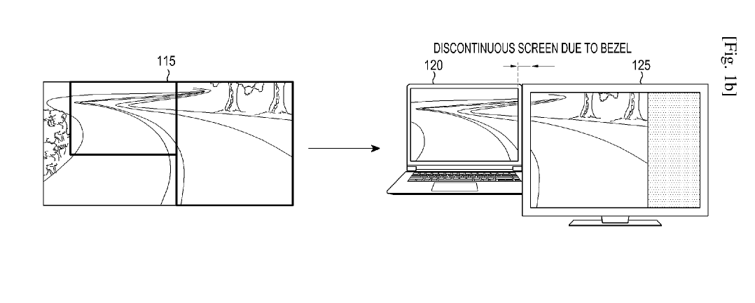

FIG. 1a illustrates an example of a case in which in the existing display expansion method, when the same content is actually displayed on a multi-screen, its view size may vary due to the difference in Pixels Per Inch (PPI) between display terminals.

Referring to FIG. 1a, a multi-display may be applied by continuously arranging a laptop computer 105 and a PC monitor 110 in the horizontal direction. The laptop computer 105 and the PC monitor 110 will be assumed to simultaneously display content 100 having a size of, for example, 500×500 pixels. It will be assumed that the laptop computer 105 has a 9-inch display screen and supports a resolution of 1024×786, and the PC monitor 110 is 15 inches in size and supports the same resolution as that of the laptop computer 105. In this case, since the display screen of the laptop computer 105 is different in PPI from the PC monitor 110, even though they display the same content 100, the physical size of the content 100 actually viewed on the screens may vary. As a result, as illustrated in FIG. 1a, the content 100 may be different in size, when it is displayed on the display screen of the laptop computer 105 and when it is displayed on the PC monitor 110.

FIG. 1b illustrates an example of a case in which in the existing display expansion method, the content is discontinuously displayed due to the difference between display terminals used for a multi-display in terms of the thickness of physical bezels of the display terminals.

Referring to FIG. 1b, a multi-display may be applied by continuously arranging a laptop computer 120 and a PC monitor 125 in the horizontal direction, like in FIG. 1a. In this case, content 115 to be displayed on the multi-display may be divided depending on the size of the display screen of the laptop computer 120 and the size of the PC monitor 125.

However, if the multi-display is actually applied to the content 115, a discontinuous area may occur due to the bezels between the laptop computer 120 and the PC monitor 125. As a result, the content 115 may be displayed in a discontinuous form over the display screen of the laptop computer 120 and the PC monitor 125.

A display expansion function and its setting for a multi-display are not specifically supported by each Operating System (OS) used by terminals equipped with a display, and this setting is not intuitively supported.

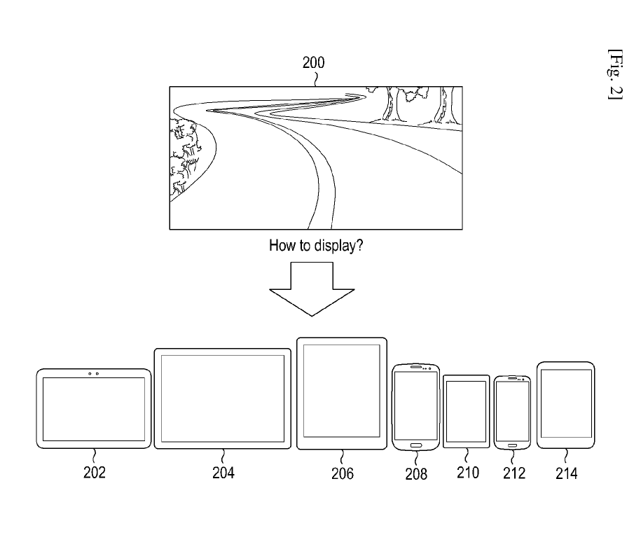

FIG. 2 illustrates an example of a case in which various heterogeneous displays are applied to content in the existing display expansion method.

As illustrated in FIG. 2, it will be assumed that there is a plurality of heterogeneous display terminals 202 to 214 that can apply a multi-display to single content 200. Since the heterogeneous display terminals 202 to 214 are different in size of their display screen, specific settings may be difficult, in which the user can directly display the content 200 in a multi-display manner.

Therefore, the present invention will provide a method for displaying single content on a multi-display screen. Specifically, the present invention provides a way to naturally display the single content on multiple display screens in the form of a single screen taking into account the PPI, bezel and the like of the display terminals to which a multi-display is applied.

The present invention defines, as a server terminal, any one of the multiple heterogeneous terminals to which a multi-display is applied, and defines, as client terminals, the other terminals except for the server terminal.

The present invention realizes the multi-display by displaying single content in an expanded display area, which is laid out using a plurality of heterogeneous display terminals, according to its exemplary embodiment. To this end, a layout of the expanded display area configured using the heterogeneous display terminals needs to be determined. Exemplary embodiments of the present invention may directly obtain a user input to determine a layout of the expanded display area, or may provide preset default layouts, allowing a user to choose one of them as the layout.

A description will now be made of an exemplary case of determining a layout of an expanded display area by directly obtaining a user input according to an exemplary embodiment of the present invention.

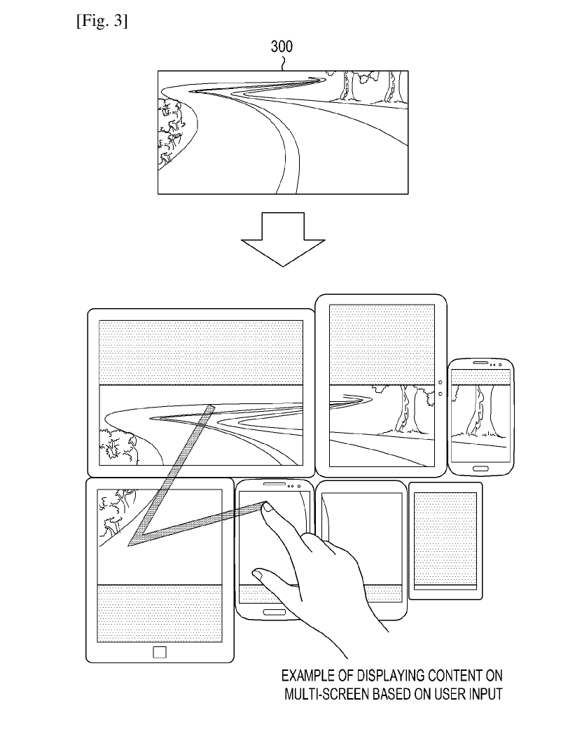

FIG. 3 illustrates an example of applying a multi-display to single content according to an exemplary embodiment of the present invention.

Referring to FIG. 3, a multi-display may be to be applied, which displays, as single content, a screen 300 showing a road, in a display area expanded using a plurality of heterogeneous display terminals. All of the terminals constituting the expanded display area need to be set in user input mode. The present invention provides a way to naturally display the screen 300 on a single screen, which is configured as display areas of the multiple heterogeneous display terminals are arranged in combination, based on the user input. An exemplary embodiment of the present invention provides a way in which the single screen 300 may be displayed in an expanded form in an expanded display area which is configured by arranging displays of heterogeneous display terminals to which a multi-display is applied, without the discontinuous or broken parts which may occur when partial areas of the screen 300, which are shown in display areas of the display terminals, are all combined, by taking into account the part where some areas of the screen 300 may be covered due to the bezels or edges of the displays of the terminals in the expanded display area comprised of display areas of a plurality of heterogeneous display terminals to which the multi-display is applied.

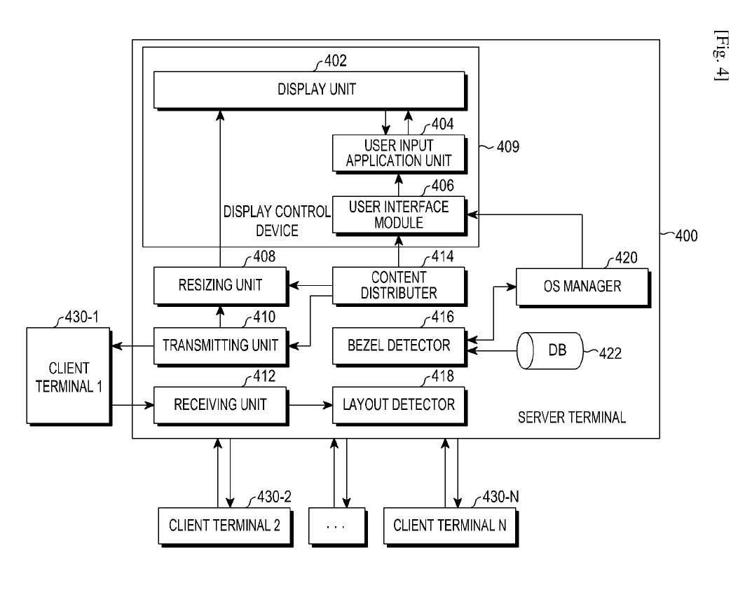

FIG. 4 illustrates an example of a structure of a server terminal according to an exemplary embodiment of the present invention. Although the units constituting the server terminal will be configured separately depending on the operation required to apply a multi-display according to an exemplary embodiment of the present invention, it will be apparent to those of ordinary skill in the art that the units may be integrated in a single unit or may be subdivided into their sub units depending on the operator's intent and/or the implementation.

Referring to FIG. 4, a server terminal 400 includes the following components to provide single content to a single screen configured by combining display areas of all client terminals (for example, a total of N client terminals #1 to #N (430-1˜430-N) including the server terminal itself.

The server terminal 400 includes a transmitting unit 410 and a receiving unit 412 for transmitting and receiving signals to/from each of the client terminals #1 to #N (430-1˜430-N), and also includes a resizing unit 408, a display control device 409, a content distributer 414, a bezel detector 416, a layout detector 418, an OS manager 420, and a Database (DB) 422.

The display control device 409 includes a display unit 402 for actually displaying a screen, a user interface module 406 for receiving a user input such as a touch and a motion, from the user, and a user input application unit 404 for converting the content to be displayed, to correspond to the user input.

The transmitting unit 410, under the instruction of the display control device 409, may send to each of the client terminals #1 to #N (430-1˜430-N) an instruction command to make a switch to the user input mode so as to display a user input request screen for determining a layout of an expanded display area for application of a multi-display.

The receiving unit 412 receives input coordinates and input time for a user input from each of the client terminals #1 to #N (430-1˜430-N) in real time. The transmitting unit 410 transmits information related to the content to be displayed, to each of the client terminals #1 to #N (430-1˜430-N).

The layout detector 418 determines a layout for the full screen constituting the multi-screen by receiving user input information and resolution information for each of the client terminals #1 to #N (430-1˜430-N). The layout detector 418 may also determine the layout using the bezel information of specific terminals, which is determined by the bezel detector 416.

The bezel detector 416 determines a bezel size of the terminal based on the user input information and resolution information for each of the client terminals #1 to #N (430-1˜430-N), which are obtained by the layout detector 418. Otherwise, the bezel detector 416 may determine the bezel size by receiving bezel information of the terminal, which is stored in advance in the DB 422.

The content distributer 414 determines a scaling factor for resizing the content to which a multi-display is to be applied, based on the layout and terminal-specific bezel related information of the client terminals, which are calculated by the layout detector 418 and the bezel detector 416, and delivers the determined scaling factor to the resizing unit 408. The resizing unit 408 resizes some areas of the content, which is to be displayed on the display unit 402 of the server terminal 400, by applying the determined scaling factor. Thereafter, the transmitting unit 410 transmits, to the client terminal, the content information, size information, Region of Interest (ROI) and the like, which are determined for each client terminal.

The DB 422 stores in advance the manufacturer-specific display information including that of the server terminal 400. The DB 422 may store display information for each of the client terminals, to which a multi-display is to be applied, the display information being obtained by the above-described components. The display information includes resolution, PPI, bezel information or the like of the terminals.

FIG. 5 illustrates an example of a structure of a client terminal according to an exemplary embodiment of the present invention. Although the units constituting the client terminal will also be configured separately depending on the operation required to apply a multi-display according to an exemplary embodiment of the present invention like in FIG. 4, it will be apparent to those of ordinary skill in the art that the units may be integrated in a single unit or may be subdivided into their sub units depending on the operator's intent and/or the implementation.

Referring to FIG. 5, a client terminal 500 is the same as the server terminal 400 except for the content distributer 414, the bezel detector 416 and the layout detector 418, in terms of the other components configured to apply a multi-display to single content using heterogeneous terminals including the client terminal 500.

Specifically, the client terminal 500 includes a display control device 509, a resizing unit 508, a transmitting unit 510, a receiving unit 512, a DB 514, and an OS manager 516. Upon receiving an instruction command to make a switch to the user input mode, the receiving unit 512 forwards the instruction command to the display control device 509. The display control device 509 is configured to display on a display unit 502 the user input request screen for determining a layout of the expanded display area. Other corresponding components are almost identical in operation to those of the server terminal 400, so a description thereof will be omitted.

The transmitting unit 510 transmits user input coordinates and user input time-related information of the client terminal 500, to the server terminal (for example, the server terminal 400 in FIG. 4). The receiving unit 512 receives, from the server terminal 400, an ROI of the content to be displayed on the display unit 502 of the client terminal 500; a scaling factor; and information about the content. The resizing unit 508 resizes the content using the ROI of content and the scaling factor, which are received from the server terminal 400.

The DB 514 stores display information of the client terminal 500. The display information of the client terminal 500 may be stored in the DB 514 in advance by the manufacturer. The DB 514 may also store display information of the client terminal itself, which is received via the transmitting unit 510 and that the server terminal 400 has detected based on a user input. The display information includes bezel information, resolution information, PPI or the like of the client terminal 500.

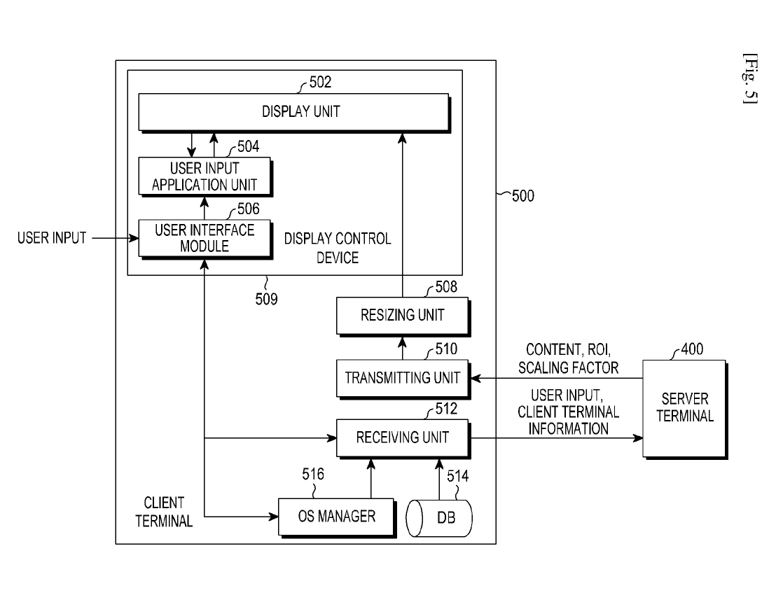

FIG. 6 illustrates a method of displaying single content in an expanded display area which is laid out using a plurality of heterogeneous display terminals, according to an exemplary embodiment of the present invention. For convenience of description, it will be assumed that a server terminal 400 and client terminals #1 and #2 (500-1 and 500-2) correspond to the server terminal 400 in FIG. 4 and the client terminal 500 in FIG. 5, respectively.

Referring to FIG. 6, it will be assumed that a screen 600, on which a ball with a smile face is displayed, is to be displayed in a multi-display manner using a total of, for example, three heterogeneous display terminals.

The server terminal 400 is larger in display area than the client terminal #1 500-1 and the client terminal #2 500-2. As a result, therefore, one expanded display screen may be configured by vertically arranging the display area of the server terminal 400 and horizontally arranging the display areas of the client terminals #1 and #2 (500-1 and 500-2).

Prior to performing multi-display, the server terminal 400 needs to recognize the display terminals, to which it will apply a multi-display, including the server terminal itself. Therefore, the server terminal 400 recognizes access of the client terminals capable of real-time data transmission/reception. As to a method of recognizing access of the terminals, the server terminal 400 may arbitrarily obtain such information as location information of the terminals either based on user inputs, or by inquiring of its nearby terminals whether a multi-display is applied, using Bluetooth and the like. For example, in an environment where Wireless Fidelity (Wi-Fi)/3^{rd} Generation (3G) networks and the like are available, the server terminal 400 may operate as a server such as a common Transmission Control Protocol/User Datagram Protocol (TCP/UDP) server, and the client terminal may access the server using a socket communication method by operating as a TCP/UDP client terminal. The server terminal 400 may wait for access from the client terminal through a socket bind operation, and if connected to the client terminal, may detect the connection.

For example, it will be assumed that the server terminal 400 has recognized the client terminal #1 500-1 and the client terminal #2 500-2 as target terminals, to which a multi-display is to be applied. In this case, the server terminal 400 requests display resolution information from each of the client terminal #1 500-1 and the client terminal #2 500-2, and receives the resolution information from the terminals. The resolution information may include, for example, horizontal and vertical sizes of a display area of the terminal, and actual size information of the terminal's screen. The resolution information may be represented as, for example, 1280×800@5.3, where 1280 denotes a pixel size in the vertical axis, 800 denotes a pixel size in the horizontal axis, and 5.3 denotes a diagonal length of the screen in inches. The server terminal 400 may store in advance in its DB 422 the resolution information of each terminal model that it frequently uses, and may obtain the resolution information using an Application Programming Interface (API) providing the resolution information included in the OS manager 420.

Thereafter, the server terminal 400 requests a user input from each of the client terminal #1 500-1 and the client terminal #2 500-2, in order to determine the display layout for configuring the expanded display area including display areas of the target terminals (for example, the client terminal #1 500-1 and the client terminal #2 500-2) to which a multi-display is to be applied, including the server terminal itself, and to determine the bezel position and thickness in the expanded display area. In this case, at least one of the server terminal 400, the client terminal #1 500-1 and the client terminal #2 500-2 may provide a user input request screen in its display area. Upon detecting a user input 601 such as a motion and a touch through its user interface module 406, the server terminal 400 calculates coordinates and input time for the user input 601. The server terminal 400 waits for the coordinates and input time of the user input 601, which are received in real time from each of the client terminal #1 500-1 the client terminal #2 500-2. Similarly, upon detecting the user input 601, the client terminal #1 500-1 and the client terminal #2 500-2 also obtain its coordinates and time information and transmit them to the server terminal 400.

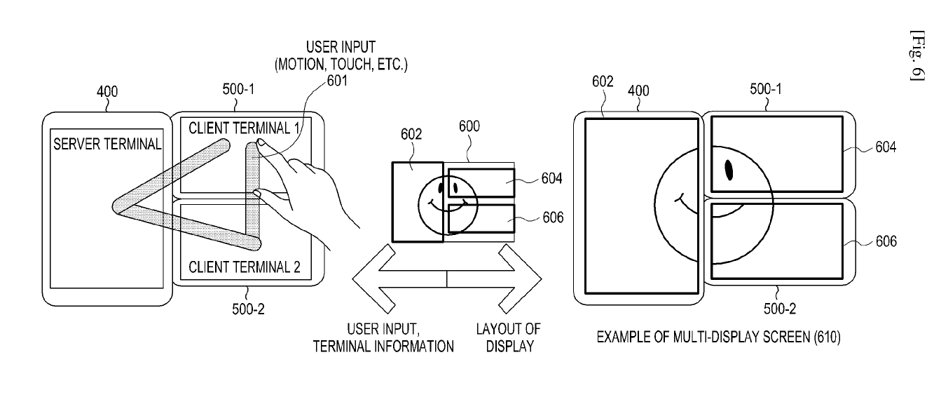

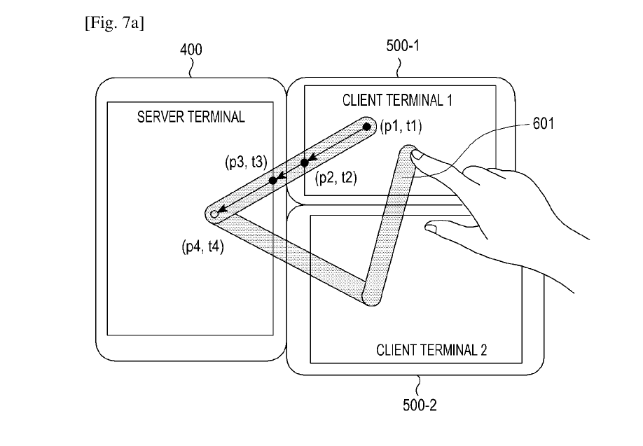

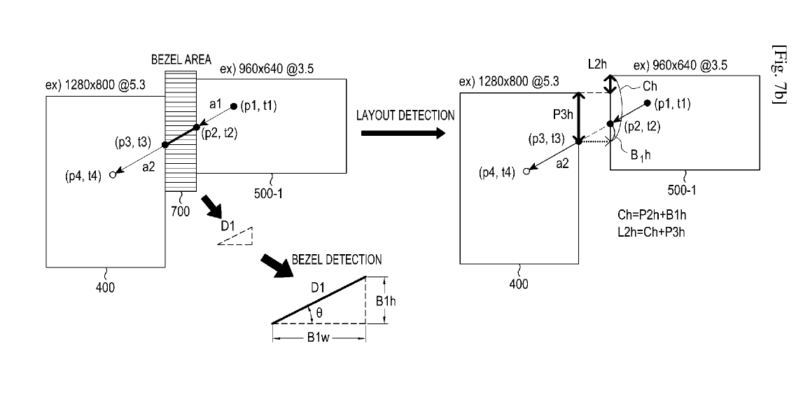

FIG. 7a illustrates an example of a user input for application of a multi-display according to an exemplary embodiment of the present invention. For convenience of description, it will be assumed that the terminals, to which a multi-display is to be applied, are arranged as illustrated in FIG. 6.

Referring to FIG. 7a, it will be assumed the user makes a touch input 601 in order of the client terminal #1 500-1, the server terminal 400 and the client terminal #2 500-2. In this case, each of the server terminal 400, the client terminal #2 500-2 and the client terminal #1 500-1 calculates coordinates and input time of the user's touch input 601 which is detected through its display area. The client terminal #2 500-2 and the client terminal #1 500-1 transmit their calculated information to the server terminal 400.

First, the client terminal #1 500-1 detects, as (p1, t1), the coordinates and time for the point where the user's touch input 601, which is detected in its display area, has started, and also detects, as (p2, t2), the coordinates and time for the point where the user's touch input 601 is terminated in the same direction. The client terminal #1 500-1 transmits this information to the server terminal 400 in real time. In (p, t), ‘p’ represents the coordinates of the point where the user's touch input is detected, and ‘t’ represents the time the user's touch input is detected. Similarly, the server terminal 400 detects, as (p3, t3), the coordinates and time for the point where the user's touch input 601, which is detected in its display area, has started, and also detects, as (p4, t4), the coordinates and time for the point where the user's touch input 601 is terminated in the same direction. The ‘p’ indicating the coordinates for the user's touch input represents the horizontal and vertical coordinates, and may be expressed as (pw, ph), where ‘pw’ denotes horizontal coordinates of the ‘p’ and ‘ph’ denotes the vertical coordinates of the ‘p’.

Next, if the server terminal 400 has obtained all of the user's touch input-related information from the target terminals, to which a multi-display is to be applied, the server terminal 400 may obtain the layout and bezel size of the terminal, to which a multi-display is applied, based on the obtained information.

FIG. 7b illustrates an example of a method of obtaining a bezel size required during application of a multi-display and a layout of a display area based on the coordinates for a user's touch input according to an exemplary embodiment of the present invention. For convenience of description, it will be assumed that the terminals, to which a multi-display is to be applied, are arranged as illustrated in FIG. 6.

In an alternative embodiment, a way to allow the user to select the layout may also be possible by providing a user selection request screen, on which preset default layouts are presented for the layout of display areas of the terminals constituting the expanded display area. As a specific example, there may be a way to select the layout of the expanded display area by providing a user selection request screen on the display of the server terminal 400. A specific example of this method will be described in detail herein below with reference to FIG. 7c.

In accordance with an exemplary embodiment of the present invention, the user input may include a touch, a motion and the like. It will be assumed that as illustrated in FIG. 7a, the user has made a touch input in a straight line from a display area of the client terminal #1 500-1 to a display area of the server terminal 400. In this case, the client terminal #1 500-1 detects the coordinates and time for the user's touch input, and transmits the detected information to the server terminal 400.

Based on the coordinates and time (for example, (p1, t1) and (p2, t2)) received from the client terminal #1 500-1, the server terminal 400 calculates a user's touch speed a1 [pixel/msec] for the client terminal #1 500-1 in accordance with Equation (1) below.

$$a 1 = \frac{\vert p 2 - p 1 \vert}{t 2 - t 1} \qquad ( 1 )$$

where a1 represents a pixel-based touch speed. Therefore, by using PPI1 of the client terminal #1 500-1 for the a1, the server terminal 400 calculates an actual screen length-based touch speed A1 (inch/msec] in accordance with Equation (2) below.

$$A 1 = \frac{\vert p 2 - p 1 \vert}{t 2 - t 1} / PPI 1 \qquad ( 2 )$$

The PPI1 may be calculated using resolution information of the client terminal #1 500-1. The resolution information of the client terminal #1 500-1 may be transmitted to the server terminal 400 together with the coordinates and times for the user touch. Alternatively, after accessing the server terminal 400, the client terminal #1 500-1 may transmit in advance the information related to the client terminal #1 500-1, to transmit its resolution information.

For example, it will be assumed that resolution information of the client terminal #1 500-1 is “960×640@3.5”. In this case, PPI1 [pixel/inch] of the client terminal #1 500-1 may be calculated using Equation (3) below.

$$PPI = \frac{{d}_{p}}{{d}_{i}} , {d}_{p} = \sqrt{{w}_{p}^{2} + {h}_{p}^{2}} \qquad ( 3 )$$

where dₚ represents a diagonal resolution in pixels of the client terminal #1 500-1, and wₚ represents a horizontal resolution in the pixels. It can be determined from the resolution information that a value of the horizontal resolution in the pixels is “640”. In addition, hₚ represents a vertical resolution in the pixels, and it can be determined from the resolution information that a value of the vertical resolution is “960”. Further, dᵢ represents a diagonal size in the pixels, and it can be determined from the resolution information that a value of the diagonal size is “3.5”. The PPI of the client terminal #1 500-1 is calculated as 248.8PPI in accordance with Equation (3). By using PPI, D [inch], the physical length, can be obtained from d [pixels], the length of the pixel domain as D=d/PPI. For convenience of description, the actual length is denoted by upper case and the pixel length is denoted by lower case.

A user's touch acceleration A [inch/msec] of the client terminal #1 500-1 can be calculated using Equation (2). Similarly, a user's touch acceleration of each terminal can be calculation using Equation (2).

The server terminal 400 may calculate a thickness of a bezel area 700 between the server terminal 400 and the client terminal #1 500-1 in the following ways. Specifically, the thickness of the bezel area 700 has its horizontal length and vertical length. Using Equation (4) below, the server terminal 400 can calculate a trajectory D1 [inch/msec] corresponding to the user's touch input in the bezel area 700.

D1=A*(t3−t2) (4)

The ‘A’ can be calculated as an average of the actual screen length-based touch speed A1 of the client terminal #1 500-1 and the actual screen length-based touch speed A2 for the user's touch input of the server terminal 400, both of which are calculated based on Equation (2). If it is not possible to calculate both of A1 and A2, the ‘A’ may be replaced with the calculated A1 or A2. The server terminal 400 can calculate a horizontal length B1w [inch) and a vertical length B1h [inch] for the user input detected in the bezel area 700, using Equations (5) and (6) below.

B1h=D1 sin θ (5)

B1w=D1 cos θ (6)

The ‘θ’ can be obtained using an angle between two points p1 and p2 obtained from the coordinates for the user's touch input of the client terminal #1 500-1, or two points p3 and p4 obtained from the coordinates for the user's touch input of the server terminal 400.

As described above, in accordance with an exemplary embodiment of the present invention, the server terminal 400 may directly calculate the bezel between the server terminal 400 and the target terminals to which it will apply a multi-display, based on the user's touch input. Alternatively, the server terminal 400 may store the bezel information of terminals in the DB 422 in advance, for various models. In this case, upon detecting access of the target terminals to which it will apply a multi-display, the server terminal 400 may check model names of the terminals. The server terminal 400 determines whether the checked model names match with terminal's model names and bezel information stored in its DB 422.

The server terminal 400 may use, for example, Equations (7) and (8) below, to determine a layout of each terminal for an expanded display area comprised of the server terminal itself and the target terminals to which it will apply a multi-display.

Ch=P2h+B1h (7)

L2h=Ch−P3h (8)

Referring to FIG. 7b, as described above, P2h [inch] represents the actual vertical length for the coordinates p2 [pixel] for the user's touch input of the client terminal #1 500-1, and P3h represents the actual vertical length for the coordinates p3 [pixel] caused by the user's touch input connected to the server terminal 400. Therefore, the vertical length Ch, which can be obtained based on the user's touch input connected from the client terminal #1 500-1 to the server terminal 400, may be calculated as a sum of P2h and B1h which is the vertical length of the bezel area 700. By detecting the length L2h determined by excluding P3h from Ch, the server terminal 400 may determine that the client terminal #1 500-1 is arranged higher by L2h than the server terminal itself.

FIG. 7c illustrates an example of a method of selecting a layout of heterogeneous terminals constituting an expanded display area by providing a user selection request screen for application of a multi-display according to another exemplary embodiment of the present invention. For convenience of description, it will be assumed that the user selection request screen is provided on the server terminal 400.

Referring to FIG. 7c, an initial screen 710 of the user selection request screen may include items such as, for example, ‘Status of Accessed Terminals’ 711, ‘Execute’ 712, ‘Detect Current Screen Configuration’ 714, ‘Configure Specified Screen’ 716 and the like.

Among the items, the ‘Status of Accessed Terminals’ 711 shows a list of terminals including the server terminal 400, to which the multi-display is to be applied. As a specific example, the ‘Status of Accessed Terminals’ 711 is assumed to include the server terminal 400 and its client terminals #1 to #3.

Using the ‘Execute’ 712, the ‘Detect Current Screen Configuration’ 714, and the ‘Configure Specified Screen’ 716 among the other items on the initial screen 710, the user may select a layout of the terminals that will constitute the expanded display area.

First, if the item of ‘Execute’ 712 is selected by the user, the initial screen 710 is switched to a switched screen #2 720. The switched screen #2 720 displays a form in which terminals included in the ‘Status of Accessed Terminals’ 711 are physically laid out in the currently expanded display area. In this case, it will be assumed that for the server terminal 400, all of the display information of the client terminals #1 to #3 constituting the ‘Status of Accessed Terminals’ 711 is stored in its DB 422. If the item of ‘Execute’ 712 is selected by the user, the actual bezel shape of the terminal is reflected depending on the display information for each of the client terminals #1 to #3, which is stored in the DB 422 of the server terminal 400, thereby providing an expanded screen in which the current physical layout status is reflected. For the content the user desires to display, an example of display of the expanded screen may be provided in a preview form. The switched screen #2 720 may additionally provide an item of ‘Improve’ 721, which is activated by a user input.

Next, if the ‘Detect Current Screen Configuration’ 714 is selected by the user, the server terminal 400 sets the user input mode for all of the terminals included in the ‘Status of Accessed Terminals’ 711. Accordingly, the server terminal 400 may send an instruction command to make a switch to the user input mode to each of the client terminals #1 to #3 through, for example, the transmitting unit 410 in FIG. 4. As a result, not only the server terminal 400, but also the client terminals #1 to #3 having received the command, may be switched to the user input mode. For example, accordingly, a user input request screen is displayed on each of the client terminals #1 to #3 including the server terminal 400, which constitute a layout 750 for the expanded display. Thereafter, the server terminal 400 may receive in real time not only the user input which is received in its display area through, for example, the user interface module 406 in FIG. 4, but also the input coordinates and input time for the user input of the terminals through the client terminals #1 to #3, and based thereon, may detect the bezel and layout in the display areas of the terminals. A detailed operation of the server terminal 400, for detecting the bezel and layout based on the input coordinates and input time is similar to that described with reference to FIGS. 3 to 7b, so a detailed description thereof will be omitted herein. An example of the multi-screen configured depending on the bezel and layout detected by the user input may be provided on the switched screen #2 720 in a preview form.

Finally, if the ‘Configure Specified Screen’ 716 is selected by the user, the initial screen 710 is switched to a switched screen #3 730. The switched screen #3 730 may include items such as, for example, ‘Select Screen Layout/Confirmation’ 731, ‘Arrange User Screens’ 732, ‘Execute on Selected Screens’ 733 and the like. Among the items on the switched screen #3 730, the item of ‘Select Screen Layout/Confirmation’ 731 shows examples of the configuration of default screens which are set in advance depending on the number of terminals included in the ‘Status of Accessed Terminals’ 711. For convenience of description, it will be assumed that the terminals included in the ‘Status of Accessed Terminals’ 711 are the same. Specific examples of the default screens may include, for example, an ‘Option #1’ 731a to select an expanded option screen configured by arranging four terminals in a row; an ‘Option #2’ 731b to select an expanded option screen configured by arranging the terminals in two rows; and an ‘Option #3’ 731c to select an expanded option screen configured by arranging two terminals in a row in the horizontal direction and arranging two other terminals beside the two terminals in the vertical direction. It will be assumed that the user selects the ‘Option #2’ 731b. In this case, if the user selects the ‘Execute on Selected Screens’ 733, the switched screen #3 730 is switched to the switched screen #2 720. At this point, the switched screen #2 720 may provide, in a preview form, an example of the layout of the terminals corresponding to the ‘Option #2’ 731b selected by the user. The switched screen #2 720, which is selected as the user touches or selects the ‘Arrange User Screens’ 732, may include the activated item of ‘Improve’ 721. Even though the user has decided to arrange the layout of terminals by selecting the ‘Configure Specified Screen’ 716, the user may decide again to re-detect the layout of terminals by making a user input depending on whether he/she accepts the screen shown on the switched screen #2 720. In this case, the user may select the improved item of ‘Improve’ 721. If the improved item of ‘Improve’ 721 is selected by the user, the server terminal 400 sends an instruction command to make a switch to the user input mode to each of the terminals constituting the layout corresponding to the ‘Option #2’ 731b. This operation has been described above, so a description thereof will be omitted herein.

As another example, if the item of ‘Execute on Selected Screens’ 733 is selected by the user, the switched screen #3 730 is switched to a switched screen #4 740. The ‘Execute on Selected Screens’ 733 may be selected, if there is no layout that the user desires to select from the default screens provided by the ‘Select Screen Layout/Confirmation’731, or if the user wants to arbitrarily apply his/her desired layout. The switched screen #4 740 provides images corresponding to the terminals included in, for example, the ‘Status of Accessed Terminals’ 711, and may provide items such as ‘Select Screens to be Arranged’ 743 by which positions of the terminals corresponding to the images can be selected by the user input, and ‘Execute on Selected Screens’ 741. The user may decide his/her desired layout by shifting positions of the images corresponding to the terminals by making a user input. In fact, the user arranges the physical positions of the terminals to correspond to the decided layout, and then selects the ‘Execute on Selected Screens’ 741. As the ‘Execute on Selected Screens’ 741 is selected, the user may enter the completed arrangement of user screens, to the server terminal 400.

If the ‘Execute on Selected Screens’ 741 is selected by the user, the switched screen #4 740 is switched to, for example, the switched screen #2 720. In this case, the switched screen #2 720 may display an expanded screen configured in the layout corresponding to the user input made on the ‘Select Screens to be Arranged’ 743, and a preview of the content applied to the expanded screen. This switched screen #2 720 may also apply the function corresponding to the item of ‘Improve’ 721.

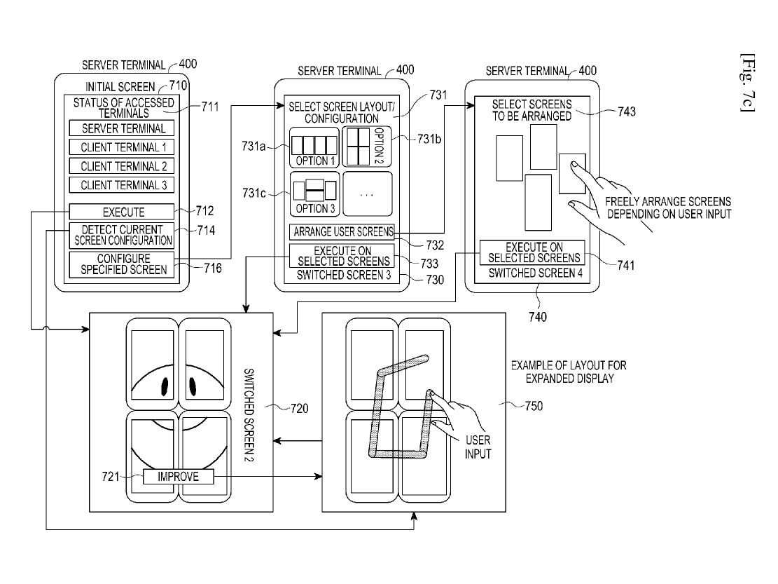

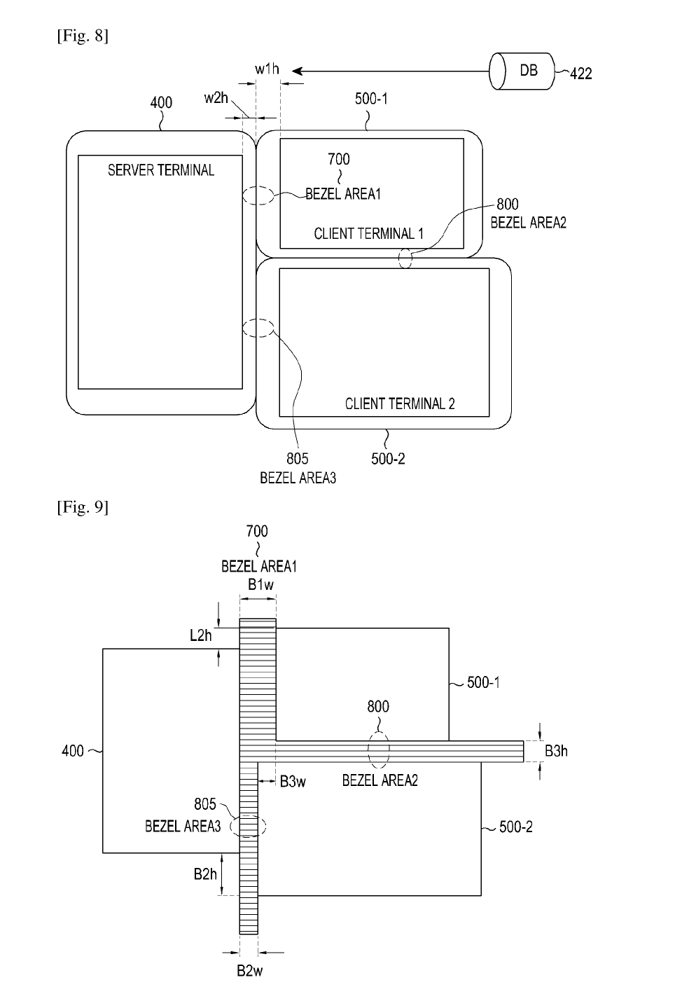

FIG. 8 illustrates an example of a case in which a server terminal stores in advance in its DB the bezel information of target terminals to which it will apply a multi-display, according to an exemplary embodiment of the present invention.

Referring to FIG. 8, the server terminal 400 checks model names of the target terminals (for example, the client terminal #1 500-1 and the client terminal #2 500-2), to which a multi-display is to be applied, including the server terminal itself. The server terminal 400 determines that the model name-specific bezel information is stored in the DB 422. Thus, the server terminal 400 obtains terminal-specific bezel information from the DB 422. For example, it will be assumed that the server terminal 400 has a bezel thickness of w2h and the client terminal #1 500-1 has a bezel thickness of w1h. In this case, the server terminal 400 may obtain its own bezel thickness and the bezel thickness of the client terminal #1 500-1 from the DB 422, and add up them to obtain, as w2h+w1h, the thickness of a bezel area #1 700 between the server terminal 400 and the client terminal #1 500-1.

As described above, it will be assumed that the terminals, to which a multi-display is to be applied, are arranged as illustrated in FIG. 6. In this case, the bezel area includes a total of three bezel areas, including the bezel area #1 700 between the server terminal 400 and the client terminal #1 500-1. In other words, the bezel area includes a bezel area #2 800 between the client terminal #1 500-1 and the client terminal #2 500-2, and a bezel area #3 805 between the server terminal 400 and the client terminal #2 500-2. Similarly, even for the bezel area #2 800 and the bezel area #3 805, the server terminal 400 may determine their thicknesses using the terminal-specific bezel information obtained from the DB 422, like that of the bezel area #1 700.

FIG. 9 illustrates an example of a layout and a bezel thickness of an expanded display area comprised of target terminals to which a multi-display is to be applied, which are obtained by a server terminal, according to an exemplary embodiment of the present invention.

Referring to FIG. 9, a horizontal length of the bezel area #1 700 is represented by B1w, and can be calculated using Equation (6). A vertical length of the bezel area #2 800 is represented by B3h, and a horizontal length of the bezel area #3 805 is represented by B2w. These values B3h and B2w can be calculated using Equation (5) and (6), respectively. By obtaining a horizontal length B3w between the client terminal #1 500-1 and the client terminal #2 500-2, the server terminal 400 may determine that in the bezel area #1 700, the client terminal #2 500-2 is arranged closer by B3w to the server terminal 400 than the client terminal #1 500-1 in the horizontal direction.

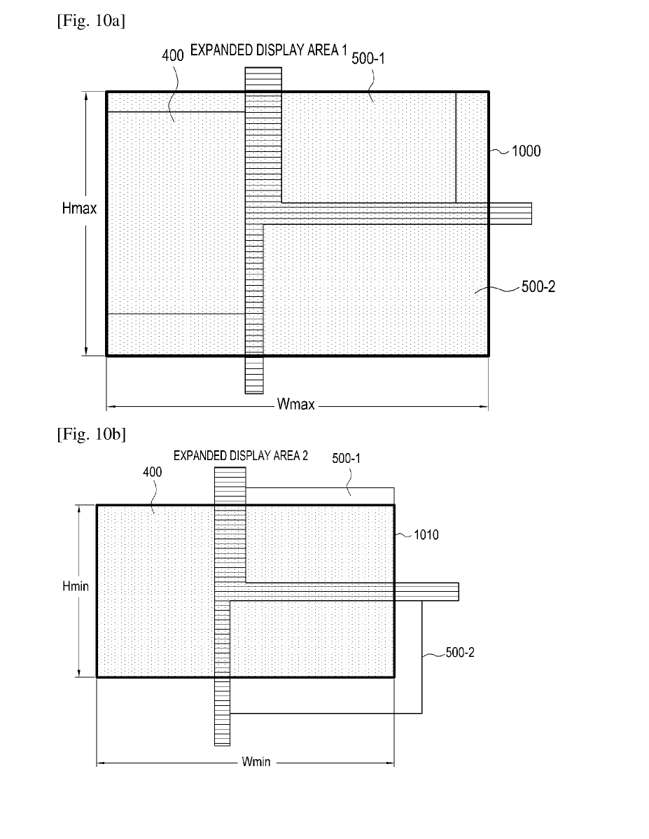

FIGS. 10a and 10b illustrate the maximum size and the minimum size of an expanded display area comprised of target terminals to which a multi-display is to be applied, which are obtained by a server terminal, according to an exemplary embodiment of the present invention, respectively.

Referring to FIG. 10a, an expanded display area #1 1000 represents the maximum size of the screen that can be obtained using display areas of the server terminal 400, the client terminal #1 500-1 and the client terminal #2 500-2. In other words, the expanded display area #1 1000 is configured to have the maximum horizontal length Wₘₐₓ and the maximum vertical length Hₘₐₓ which can be obtained using the display areas of the server terminal 400, the client terminal #1 500-1 and the client terminal #2 500-2.

Referring to FIG. 10b, an expanded display area #2 1010 represents the minimum size of the screen that can be obtained using display areas of the server terminal 400, the client terminal #1 500-1 and the client terminal #2 500-2. In other words, the expanded display area #2 1010 is configured to have the minimum horizontal length Wₘᵢₙ and the minimum vertical length Hₘᵢₙ which can be obtained using the display areas of the server terminal 400, the client terminal #1 500-1 and the client terminal #2 500-2.

In accordance with an exemplary embodiment of the present invention, an expanded display area, to which a multi-display is applied, may have the maximum size and the minimum size for the server terminal, as described above. A screen size corresponding to any one of the minimum size and the maximum size may be determined arbitrarily by the user input.

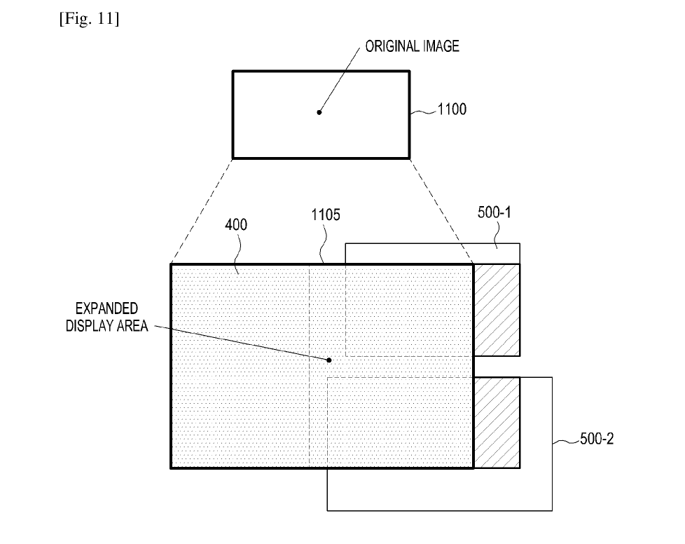

FIG. 11 illustrates an example in which content is placed, when the minimum size of an expanded display area is selected, to which a multi-display is applied, according to an exemplary embodiment of the present invention.

Referring to FIG. 11, an expanded display area 1105 is configured to have the minimum vertical length and the minimum horizontal length, which can be obtained from display areas of the server terminal 400, the client terminal #1 500-1 and the client terminal #2 500-2. It will be assumed that the server terminal 400 has determined to display an original image 1100 in the expanded display area 1105. In this case, the original image 1100 is enlarged to the size corresponding to the expanded display area 1105, and relocated in the expanded display area 1105.

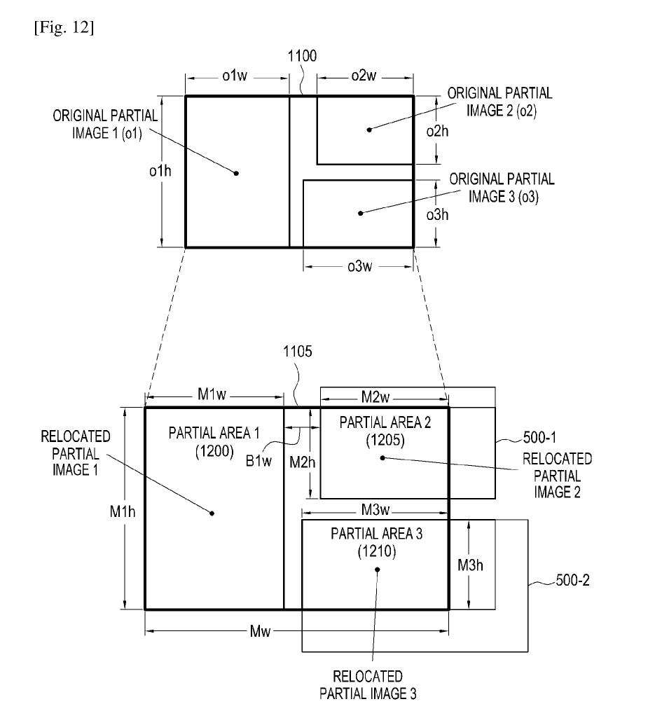

FIG. 12 illustrates exemplary display of content relocated in an expanded display area according to an exemplary embodiment of the present invention.

Referring to FIG. 12, since the expanded display area 1105 includes the display areas of the server terminal 400, the client terminal #1 500-1 and the client terminal #2 500-2, the original image 1100 is divided into three partial images (for example, an original partial image #1 o1 to an original partial image #3 o3) corresponding to the display areas. Specifically, the expanded display area 1105 is comprised of a first partial area 1200 corresponding to the display area of the server terminal 400, a second partial area 1205 corresponding to the display area of the client terminal #1 500-1, and a third partial area 1210 corresponding to the display area of the client terminal #2 500-2. The expanded display area 1105 includes a bezel area #1 between the first partial area 1200 and the second partial area 1205, a bezel area #2 between the second partial area 1205 and the third partial area 1210, and a bezel area #3 between the first partial area 1200 and the third partial area 1210.

The original partial image #1 of is relocated in the first partial area 1200. As for the size, the original partial image #1 o1 has a horizontal length o1w [pixel] and a vertical length o1h [pixel]. The original partial image #1 o1 is enlarged to the size corresponding to the horizontal length M1w [inch] and the vertical length M1h [inch] of the first partial area 1200, and relocated in the first partial area 1200. Similarly, as for the size, the original partial image #2 o2 has a horizontal length o2w and a vertical length o2h. The original partial image #2 o2 is enlarged to the size corresponding to the horizontal length M2w and the vertical length M2h of the second partial area 1205, and relocated in the second partial area 1205. Finally, as for the size, the original partial image #3 o3 has a horizontal length O3w and a vertical length O3h. The original partial image #3 o3 is enlarged to the size corresponding to the horizontal length M3w and the vertical length M3h of the third partial area 1210, and relocated in the third partial area 1210.

Specifically, based on its resolution, the server terminal 400 calculates the sizes in which it will relocate the original partial images in the expanded display area 1105. First, the server terminal 400, as described above, obtains its PPI for example, PPI1 in accordance with Equation (3) using its resolution information. Based on PPI, the server terminal 400 converts the pixel-based vertical length o1h_(pixel) of the original image into an inch-based vertical length O1h_(inch). In this way, the server terminal 400 may obtain a scaling factor S1 between the vertical length O1h of the original image and the vertical length M1h of the display area in which the partial image is to be relocated. The S1 may be calculated using the pixel-based horizontal length o1w_(pixel) of the original partial image o1. Thereafter, based on the S1, the server terminal 400 may obtain the vertical length of the display area in which the partial image is to be relocated, with respect to the horizontal length of the original image 1100.

As for a horizontal length M2w of the partial area #2 1205, the server terminal 400 may obtain a length of “M2w_(inch)=Mw−M1w−B1w”, which is determined by excluding the horizontal length M1w of the partial area #1 1200 and the horizontal length B1w of the bezel area between the partial area #1 1200 and the partial area #2 1205 from the total length Mw of the expanded display area 1105. The server terminal 400 may calculate the horizontal length M2w as a pixel-based horizontal length of” m2w_(pixel)=M2w×PPI2″ by applying the resolution information obtained in advance from the client terminal #1 500-1 and the PPI2 obtained in accordance with Equation (3). The server terminal 400 may obtain a scaling factor S2 (=m2w/o2w) for calculation of the size used to relocate the original partial image #2 o2 in the second partial area 1205, by applying a proportional expression (Mw:M2w=Ow:O2w) between the total length Mw of the expanded display area 1105 and the horizontal length M2w of the partial area #2 1205. In this way, the content distributer 414 in the server terminal 400 resizes a partial image from the original image 1100, and determines whether to deliver it to the terminals constituting the expanded display area 1105. The server terminal 400 transmits the scaling factor and the partial image ROI that the terminal will display, out of the original image 1100, to each of the client terminal #1 500-1 and the client terminal #2 500-2 through the transmitting unit 410. Upon receiving this information, each client terminal resizes the partial image area corresponding to the ROI in the original image 1100 using the scaling factor by controlling its resizing unit 508, and transfers the results to its display control device 509. Then, the display control device 509 controls the display unit 502 to display only the resized partial image area, and crops or pads the other areas. Similarly, the resizing unit 408 of the server terminal 400 may also resize the partial image area corresponding to its ROI depending on its scaling factor, and transfer it to the display control device 409. Then, the display control device 409 controls the display unit 402 to display only the resized partial image area, and crops or pads the other areas.

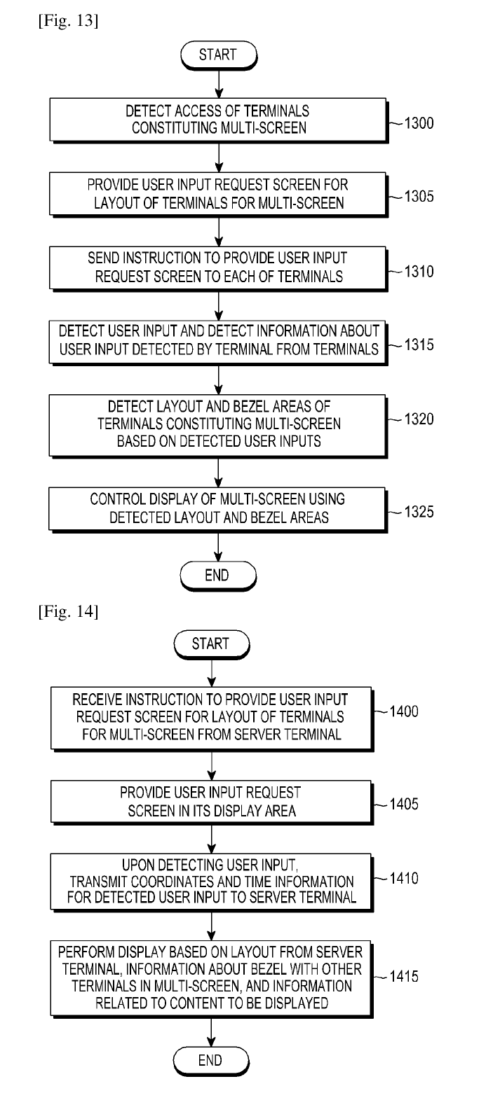

FIG. 13 is a flowchart illustrating an exemplary operation of a server terminal according to an exemplary embodiment of the present invention.

Referring to FIG. 13, upon detecting access or connection of terminals which are to constitute a multi-screen in step 1300, the server terminal provides or displays a user input request screen for a layout of the terminals for the multi-screen in step 1305. The user input request screen may be provided in the form of an option screen on which the detected terminals may be arbitrarily arranged, or of a default screen showing examples of a multi-screen comprised of the terminals.

In step 1310, the server terminal sends an instruction to provide the user input request screen, to each of the terminals.

Thereafter, in step 1315, the server terminal detects a user input from its user, and detects information about the user input detected by the terminals, from the terminals. The user input corresponds to a touch, a motion or the like, and may be comprised of coordinates indicating the position of the user input and information indicating the input time of the user input. This information has been described above, so a detailed description thereof will be omitted herein.

In step 1320, based on the detected user inputs, the server terminal detects the layout and bezel areas of the terminals which are to constitute the multi-screen. The detection process has been described in connection with FIGS. 7a and 7b, so a detailed description thereof will be omitted herein. If the server terminal stores in advance in its DB the resolution information and bezel area-related information for each of the terminals, the server terminal may read out the information from the DB and use it to detect the layout and bezel areas of the terminals.

In step 1325, the server terminal controls display of the multi-screen using the detected layout and bezel areas. The control process includes determining an area in which an image is to be actually displayed, within a range of the size of the expanded display area, which is included in the layout, and resizing the original image to be displayed, to correspond to the size of the expanded display area. The determining and resizing processes have been described with reference to FIGS. 9 to 12, so a detailed description thereof will be omitted herein.

FIG. 14 is a flowchart illustrating an exemplary operation of a client terminal according to an exemplary embodiment of the present invention.

Referring to FIG. 14, in step 1400, the client terminal receives from a server terminal an instruction to provide a user input request screen for a layout of the terminals for a multi-screen. In step 1405, the client terminal provides the user input request screen in its display area. The user input request screen may be provided in the form of an option screen on which the detected terminals may be arbitrarily arranged, or of a default screen showing examples of a multi-screen comprised of the terminals.

Thereafter, in step 1410, upon detecting a user input, the client terminal transmits its coordinates and time information to the server terminal. This information has been described above, so a detailed description thereof will be omitted herein.

In step 1415, the client terminal performs display based on the layout and information about the bezel between the client terminal and other terminals in the multi-screen, which are received from the server terminal, and information related to the content to be displayed. The display process by the client terminal includes, as described with reference to FIG. 12, resizing some image of the original image, which corresponds to the information obtained from the server terminal, and displaying the resized image.

As described above, the server terminal calculates the ROI of a terminal in the original image, the bezel area and the resizing information for the client terminals which will perform multi-display with the server terminal, and transmits the resulting information to each of the other client terminals. As a result, each of the server terminal and the client terminals resizes the ROI it will display, so as to correspond to the size information received from the server terminal, and then outputs the resized image taking the bezel area into account, so that the expanded original image may be displayed to correspond to the expanded display area just like a single screen without a discontinuous part.

While the invention has been shown and described with reference to certain exemplary embodiments thereof, it will be understood by those skilled in the art that various changes in form and details may be made therein without departing from the spirit and scope of the invention as defined by the appended claims and their equivalents.

1. A method for displaying single content using a multi-screen comprised of heterogeneous terminals in a server terminal, the method comprising: providing a user input request screen for a layout of the multi-screen when detecting access of client terminals which are to constitute the multi-screen; detecting the layout and a bezel area between the server terminal and the client terminals on the multi-screen using a user input after sending an instruction to provide the user input request screen to each of the client terminals; controlling display of the multi-screen using the detected layout and bezel area; and wherein the layout for the multi-screen is comprised of the server terminal and the client terminals, the user input is detected by the server terminal, and user inputs received from the client terminals.

2. The method of claim 1, the method further comprising: calculating units of Pixels Per Inch (PPI) based on the resolution information for each client terminal, after obtaining resolution information from each of the client terminals; converting coordinates and time information in units of the PPI; obtaining the layout and bezel information for each of the client terminals using the coordinates and time information converted in units of the PPI; and transmitting bezel information and layout-related information to each of the client terminals wherein the coordinates and time information is determined to the user input which detected by the server terminal and each of the user inputs received from the client terminals.

3. The method of claim 2, wherein the controlling of the display of the multi-screen comprises: determining a display area within a range of a size of an expanded screen included in the detected layout; resizing an original image expanded to correspond to the display area using a size of the display area and a size of the original image to be displayed on the multi-screen; and providing resizing-related information for the original image to the client terminals.

4. The method of claim 3, wherein the resizing-related information for the original image includes information about the original image divided to correspond to a partial display area constituting the display area, and size information for the partial display area, for each of the client terminals.

5. The method of claim 1, further comprising: determining whether information about arrangement between the server terminal and each of the client terminals exists in a database that stores, in advance, terminal-specific resolution information and bezel information when detecting access of the client terminals; and detecting the layout and the bezel area without the user input request screen when information about arrangement between the server terminal and each of the client terminals exists in the database, and transmitting information about the detection to each of the client terminals, wherein the detected layout and bezel area without the user input request screen is comprised to the information about arrangement between the server terminal and each of the client terminals.

6. A method for displaying single content using a multi-screen comprised of heterogeneous terminals in a client terminal, the method comprising: receiving, from a server terminal, an instruction to provide a user input request screen for a layout of client terminals for the multi-screen; transmitting coordinates and time information for the user input to the server terminal when detecting a user input; performing display based on the layout, information about a bezel between the client terminal and other client terminals in the multi-screen, and information related to content to be displayed; and wherein the layout and the information about the bezel is obtained from the server terminal.

7. The method of claim 6, wherein the content-related information includes resizing-related information for an original image which is to be displayed on the multi-screen and size information of the partial display area; wherein the resizing-related information for an original image is divided to correspond to a partial display area constituting a display area within a range of a size of an expanded screen which is included in the layout for each of the client terminals.

8. The method of claim 7, further comprising: providing a screen used for selecting a size of the display area within the range of the size of the expanded screen depending on an instruction of the server terminal.

9. A server terminal for displaying single content using a multi-screen comprised of heterogeneous terminals, comprising: a transmitting/receiving unit for sending an instruction to provide a user input request screen to each of the client terminals and receiving user inputs from the client terminals; a controller for providing the user input request screen for a layout of the multi-screen, detecting access of client terminals which are to constitute the multi-screen and the layout and a bezel area between the server terminal and the client terminals on the multi-screen, based on the user inputs, and controlling display of the multiscreen using the detected layout and bezel area; and wherein the layout for the multi-screen is comprised of the server terminal and the client terminals, the user input is detected by the server terminal, and user inputs received from the client terminals.

10. The server terminal of claim 9, wherein the controller is configured to, calculate units of Pixels Per Inch (PPI) based on the resolution information for each client terminal after obtaining resolution information from each of the client terminals; convert coordinates and time information in units of the PPI; obtain the layout and bezel information for each of the client terminals using the coordinates and time information converted in units of the PPI; control the transmitting/receiving unit to transmit bezel information and layout-related information to each of the client terminals; and wherein the coordinates and time information is determined to the user input which detected by the server terminal and each of the user inputs received from the client terminals.

11. The server terminal of claim 10, wherein the controller is configured to, determine a display area within a range of a size of an expanded screen included in the detected layout; resize an original image expanded to correspond to the display area using a size of the display area and a size of the original image to be displayed on the multi-screen; and control the transmitting/receiving unit to provide resizing-related information for the original image to the client terminals.

12. The server terminal of claim 11, wherein the resizing-related information for the original image includes information about the original image divided to correspond to a partial display area constituting the display area, and size information for the partial display area, for each of the client terminals.

13. The server terminal of claim 9, wherein the controller is configured to, determine whether information about arrangement between the server terminal and each of the client terminals exists in a database that stores, in advance, terminal-specific resolution information and bezel information when detecting access of the client terminals; and detect the layout and the bezel area without the user input request screen when information about arrangement between the server terminal and each of the client terminals exists in the database, and control the transmitting/receiving unit to transmit information about the detection to each of the client terminals; wherein the detected layout and bezel area without the user input request screen is comprised to the information about arrangement between the server terminal and each of the client terminals.

14. A client terminal for displaying single content using a multi-screen comprised of heterogeneous terminals, comprising: a transmitting/receiving unit for receiving, from a server terminal, an instruction to provide a user input request screen for a layout of client terminals for the multi-screen, and transmitting coordinates and time information for the user input to the server terminal when detecting a user input; and a controller for performing display based on the layout, information about a bezel between the client terminal and other client terminals in the multi-screen, and information related to content to be displayed; and wherein the layout and the information about the bezel is obtained from the server terminal.

15. The client terminal of claim 14, wherein the content-related information includes resizing-related information for an original image which is to be displayed on the multi-screen and size information of the partial display area; wherein the resizing-related information for an original image which is divided to correspond to a partial display area constituting a display area within a range of a size of an expanded screen which is included in the layout, for each of the client terminals.

16. The client terminal of claim 15, wherein the controller is configured to provide a screen used for selecting a size of the display area within the range of the size of the expanded screen depending on an instruction of the server terminal.
